(19) United States
(12) Patent Application Publication
(10) Pub. No.: US 2025/0254765 A1
(43) Pub. Date: Aug. 7, 2025

(54) INSULATOR FOR INDUCTION APPLIANCE

(71) Applicant: WHIRLPOOL CORPORATION, Benton Harbor, MI (US)

(72) Inventor: Fabiano CHINAZZO, Cassinetta (IT)

(21) Appl. No.: 18/435,341

(22) Filed: Feb. 7, 2024

(51) Int. Cl. H05B 6/12

(52) U.S. Cl. CPC H05B 6/1245

(57) ABSTRACT

An inductive cooking appliance designed for half-bridge, full-bridge and quasi-resonant inverters may include a cooking coil for the inductive cooking appliance, a cooktop configured to receive a cooking item, wherein the cooking coil and the cooktop are mutually spaced so as to define a clearance distance, and a spacer arranged between the cooktop and the cooking coil, the spacer having a first face abutting the cooktop and a second face abutting the coil, wherein a length of either lateral side of the spacer creates a creepage distance between the first face and the second face in the cross-section that is greater than the clearance distance between the cooking coil and the cooktop.

### TECHNICAL FIELD

Disclosed herein are insulators for induction cooktop appliances.

### BACKGROUND

Induction cooking appliances use induction coils to heat suitable cookware directly. For instance, the induction coils may directly heat pots and pans bottom through a magnetic induction field. An electric current is passed through the coil wire placed underneath the surface, creating a magnetic flux that, inducing eddy current throughout the pot or pan above, produces heat by means of the Joule's effect. Thus, as opposed to other types of cooking appliances, the surface of induction cooking appliances stays relatively cool while maintaining a consistent temperature on pots and pans and delivering power with a higher efficiency and finer adjustment.

### SUMMARY

An inductive cooking appliance designed for half-bridge and full-bridge inverters may include a cooking coil for the inductive cooking appliance, a cooktop configured to receive a cooking item, wherein the cooking coil and the cooktop are mutually spaced so as to define a clearance distance, and a spacer arranged between the cooktop and the cooking coil, the spacer having a first face abutting the cooktop and a second face abutting the coil, wherein a length of either lateral side of the spacer creates a creepage distance between the first face and the second face in the cross-section that is greater than the clearance distance between the cooking coil and the cooktop.

An inductive cooking appliance designed for half-bridge, full-bridge inverters and quasi-resonant inverters, may include a cooking coil for the inductive cooking appliance, a cooktop configured to receive a cooking item, and a spacer arranged between the cooktop and the cooking coil, the spacer having a first face and a second face arranged between the coil and the cooktop, wherein between the two faces there is a shape variation that creates a creepage distance between the first and second face that is greater than a clearance distance between the cooking coil and the cooktop.

A spacer for an inductive cooking appliance may include a first face and a second face opposite the first face, the first face having a first length, the second face having a second length, wherein between the two faces there is a shape variation that increases the creepage between the first and second side.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a cross-sectional view of an induction cooking system having a spacer arranged between a cooktop and induction coils;

FIG. 2 illustrates a cross-sectional view of another example induction cooking system, where a second insulating layer is arranged between the spacer and the cooktop;

FIG. 3 illustrates a cross-sectional view of another example induction cooking system, where a second insulating layer is arranged between the spacer and the coil;

FIG. 4 illustrates a cross-sectional view of another example induction cooking system, where a second spacer is arranged between a second insulating layer and the coil;

FIG. 5 illustrates a perspective view of an example of a spacer according to one embodiment;

FIG. 6 illustrates a cross-sectional view schematically showing a spacer according to one embodiment and the related clearance distance, creepage distance, and solid insulation;

FIG. 7A illustrates an example spacer having an hour-glass or concave-like cross-section;

FIG. 7B illustrates an example spacer having a convex-like cross-section;

FIG. 7C illustrates an example spacer having an asymmetrical profile or cross-section;

FIG. 8A illustrates a cross-sectional view of an example spacer profile including a second material arranged within the spacer; and

FIG. 8B illustrates a cross-sectional view of another example spacer profile including the second material.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Cooktops or other induction cooking appliances include induction coils, often referred to as pancake coils due to their structure. When powered, these coils create a magnetic field, which in turn, can be used to heat up a cooking vessel or other cooking item formed of ferromagnetic material placed on the cooktop. The cooking item may be referred to herein as a load. When an alternating current (AC) passes through the winding, the current creates a magnetic field that induces an eddy current into the load, thus heating up the bottom of the load due to the Joule effect. Spacers and mica layers are generally used between the coil winding and the surface to create a distance and an electrical insulation with the glass surface. This distance also guarantees inductor thermal insulation and provides the required safety to customers.

The induction coils are designed to meet certain standards, such as IEC 60335. Certain insulation effects are required in the coil designs, and certain minimum requirements between the electrical active parts and the end user are imposed. In one example, a minimum superficial distance between the coil and a cooktop is outlined. Such distance may depend on the working voltage, pollution degree, and material group. Other requirements such as clearances (minimum distances through air) and solid insulation (separation by means of solid insulation), are also outlined. Existing solutions to meet these standards often include a combination of spacers, mica layers, mineral wool, etc. These solutions often include an extra mica layer in between the spacer and the cooktop surface, and/or mineral wool arranged between the cooktop mica and the coil. However, oftentimes heat flux is blocked by these materials.

Disclosed herein is a spacer to be arranged between the coil and the cooktop. The spacer may include a first face or side and a second face or side (e.g., a top and bottom respectively) where between the two faces there is a shape variation that increases a creepage distance, i.e. the distance between the electrical active part and the cooktop, by using at least one slope between the faces. In one example, the spacer may be a trapezoid shape in cross-section. In this example the spacer may have a wider base while the top may be dimensioned similar to existing spacers, which generally have a rectangular parallelepiped shape. In this way, the creepage distance is increased due to the slope. This allows the standards of IEC 60335 to be met without requiring a second material or additional insulation system. As such, in addition to the improved thermal behavior of the cooktop, part and manufacturing costs decrease. Notably, additional profiles or cross-sections may also be appreciated, such as an hourglass shape, or bell-curved shape.

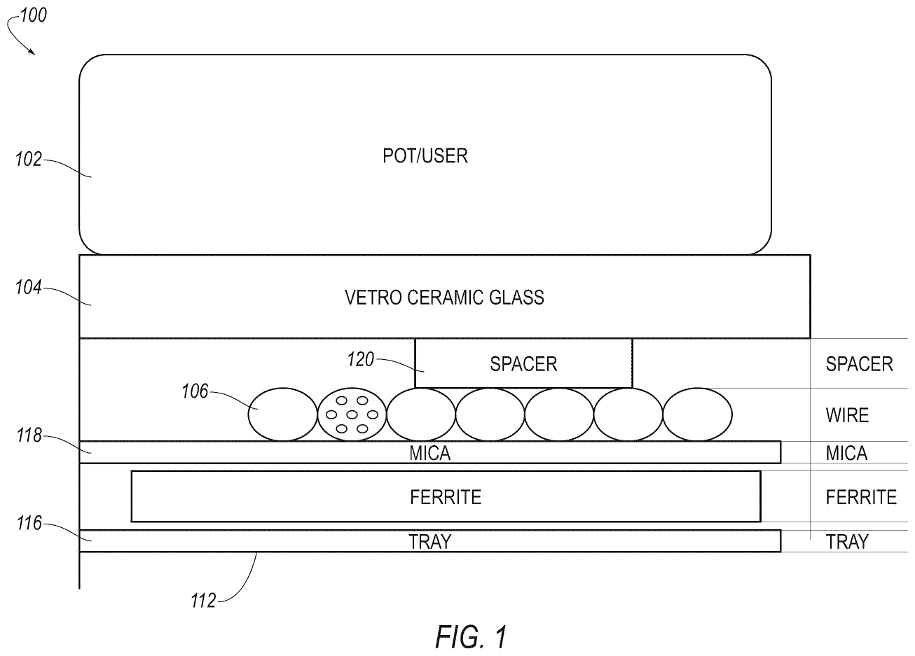

FIG. 1 illustrates a cross-sectional view of a generic induction cooking system 100. The system 100 may be an induction cooktop configured to generate an electromagnetic field to rapidly and directly heat a load 102 placed thereon. The load 102 may be any type of cooking vessel or other cooking item configured to conduct and withstand high heat, such as a pot, pan, griddle, etc. In the examples discussed herein, the load 102 is made of metal, and more specifically a metal containing iron, such as a stainless steel cooking item. However, other highly magnetic metals may additionally or alternately be used. The system 100 may include a cooktop 104 for receiving the load 102. The cooktop 104 may be formed of glass, ceramic, a glass-ceramic material, or another high-heat resistant surface.

An induction coil winding 106 is arranged below the cooktop 104. The induction coil 106 may be a copper coil or another material suitable for electric flux (such as aluminum or CCA, copper clamped aluminum, or other) configured to receive electrical current from a power source. The power source may supply high frequency AC by an electronic board, in a range greater than 18 kHz. The alternating current may generate magnetic flux, creating an electromagnetic field that causes electrons to vibrate within the load 102. The vibrating electrons create heat, thus heating the bottom surface of the load 102. The load 102 may then heat the contents of the load 102 through conductive heat.

The electromagnetic field is converted into thermal energy directly, creating an efficient heating mechanism. Because of the direct conversion, the amount of heat generated may be easily and effectively controlled by controlling the strength of the magnetic field. Further, because the load 102 is heated with a magnetic field, the cooktop 104 remains generally cool.

During use, while the cooktop 104 may remain cool, the coil winding 106 may generate heat. The system 100 may include a tray 112 arranged below the coil winding 106 to disperse and prevent the coil winding 106 from becoming too hot. The tray 112 may structurally maintain the coil winding 106 within a cooktop assembly or cabinet. The tray 112 may reduce electromagnetic noise generated by the coil winding 106 and also acts as an electromagnetic barrier configured to block the eddy currents generated by coil winding 106.

A ferrite bar group 116 may be arranged between the tray 112 and the coil 106. The ferrite bar group 116 may include a plurality of bars. The ferrite group 116 may be used to shield the electromagnetic flux generated by the coil winding 106. By using the bar group 116 to block and/or reflect the electromagnetic field, the leakage and energy loss is accordingly reduced.

An insulator layer 118 may be arranged between the ferrite group 116 and the coil 106. The insulator layer 118 may be a mica layer or a plastic structure configured to further insulate the system 100 against heat.

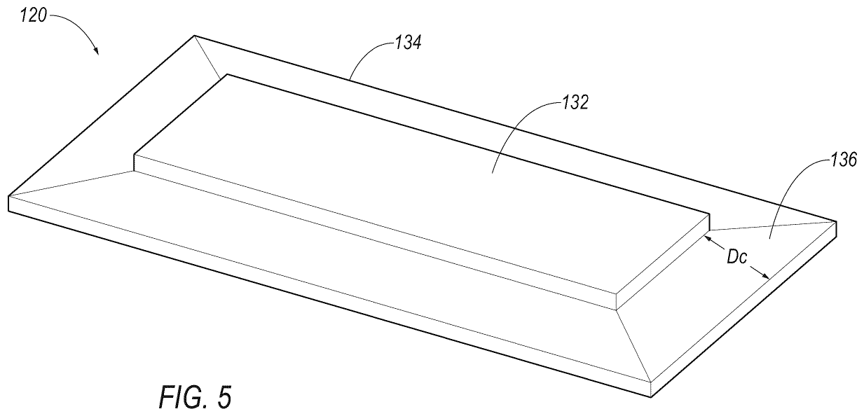

A spacer 120 may be arranged between the cooktop 104 and the coil 106. The spacer 120 may be formed of an electrically insulating material such as silicone, in one example. The spacer 120 may also include a melt or combination of plastic, rubber, or other materials with electromagnetic insulation properties. The spacer 120 is discussed in more detail with respect to FIGS. 5-8.

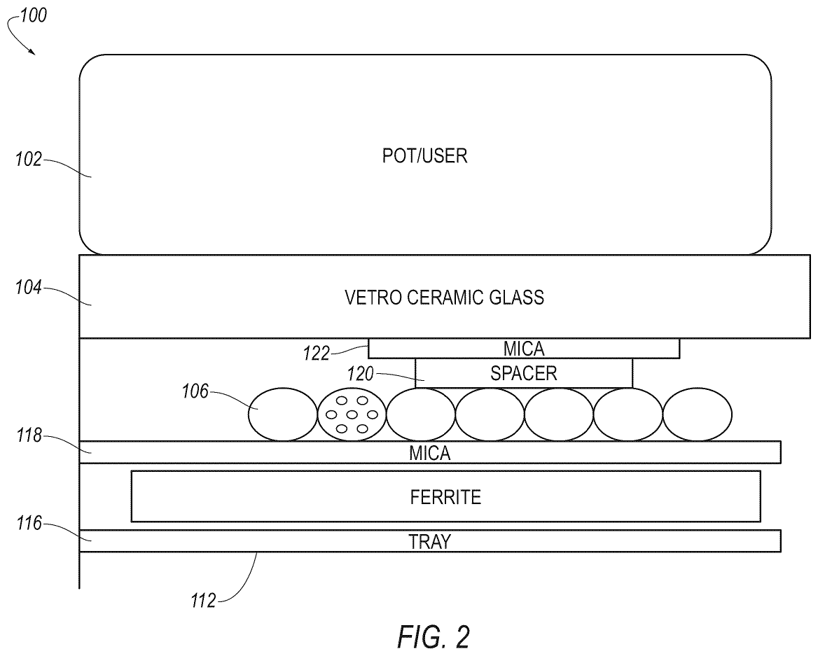

FIG. 2 illustrates a cross-sectional view of another example of a generic induction cooking system 100, where a second insulating layer 122 is arranged between the spacer 120 and the cooktop surface 104. Thus, additional insulating material may be used.

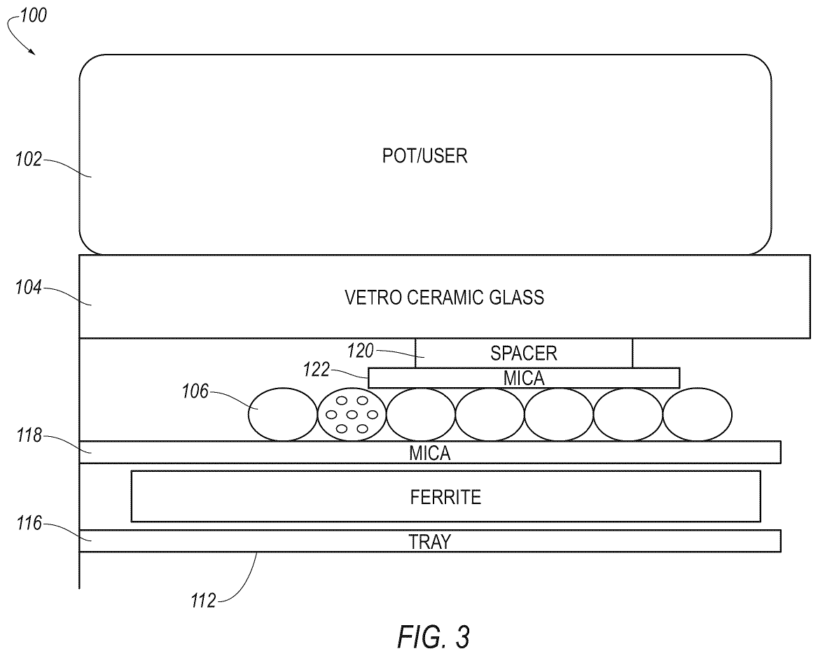

FIG. 3 illustrates a cross-sectional view of another example of a generic induction cooking system 100, where a second insulating layer 122 is arranged between the spacer 120 and the coil 106.

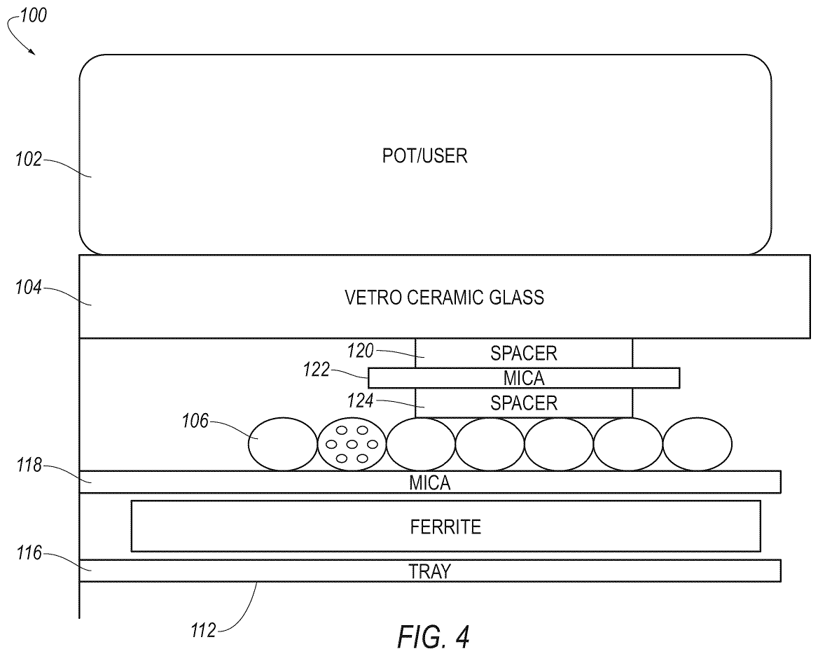

FIG. 4 illustrates a cross-sectional view of another example of a generic induction cooking system 100, where a second spacer 124 is arranged between a second insulating layer 122 and the coil 106. That is, two spacers 120, 124 may be used in this example.

FIG. 5 illustrates a perspective view of an example spacer 120 according to one embodiment. The spacer 120 may include a first face 132 and a second face 134 (e.g., a top and bottom respectively). The first face 132 may have a first surface area and the second face 134 may have a second surface area. The second surface area of the second face 134 may be greater than the first surface area of the first face 132. In the illustrated example, the spacer has a pyramid-like shape, which results in a cross-section having a substantially trapezoid shape. As anticipated above, the surface between the first face 132 and the second face 134 is referenced to as the creepage 136. The creepage 136 may be obtained from a slope from the edge of the first face 132 to the edge of the second face 134. The creepage 136 may extend across a linear surface between the first face 132 and the second face 134 forming a creepage distance Dc. The creepage distance Dc allows a greater distance to exist between the electrical active part, i.e. the coil, and the cooktop, where an end-user typically operates during a cooking process. This allows the standards of IEC 60335 to be met without requiring a second material or additional electrical insulation system.

By way of example, according to the IEC 60335 standard for half-bridge induction appliances the required creepage has to be 4.0 mm with a voltage of 250V, an induction coil placed in an ambient with a pollution degree 3 and the material group classified as the worst IIIa/IIIb due to the fact the comparative tracking index (CTI) is between 100 and 400. The clearance instead may be required to be 1.5 mm being the rated impulse voltage 2500V and the related overvoltage category II.

In the case of a full-bridge induction appliance, it is possible to implement a coil feet at 125V and in this case, maintaining the traditional induction ambient conditions, the creepage distance can decrease at 2.4 mm while the minimum clearance drops at 0.5 mm.

According to a third example, the appliance 100 may have separate coils from the cooktop IPC fan with a physical insulation thus moving the ambient pollution degree from 3 to 2. In this condition, the same half-bridge system described above may have a creepage of 2.5 mm while the clearance remains 1.5 mm. In the same way, with a pollution degree 2, a full-bridge inverter, will require a creepage of 1.5 mm and a clearance of 0.5 mm being the coil feeding voltage at 125 V.

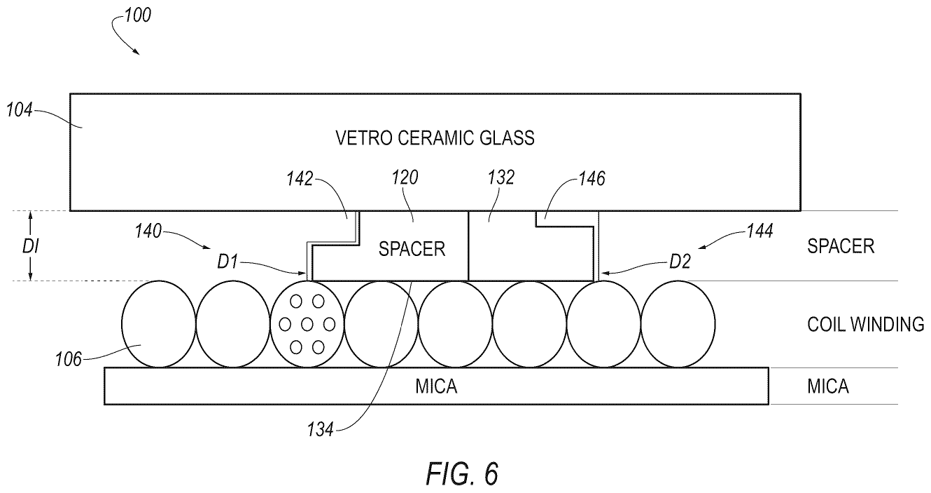

FIG. 6 illustrates a side view of a cooking system 100. It is known that the creepage distance Dc is the distance along the creepage 136 between two conducting points or between a conductive part and the bounding surface of the equipment along the surface of an insulating material. At the same time, clearance distance D1 is the shortest distance in the air between the same two conducting parts. In the case of an induction cooking appliance, the clearance distance D1 is typically the distance between the cooktop 104, e.g. a glass-ceramic cooktop, and the underlying cooking coil 106, while the creepage distance Dc is defined by the length of either face of the spacer 120 arranged between cooktop 104 and coil 106, when seen in cross-section.

According to the examples described herein, a length of either side of the spacer when seen in cross-section is such that a creepage distance Dc between the first face 132 and the second face 134 that is greater than the clearance distance D1 between the cooking coil 106 and the cooktop 104 As shown in FIG. 5, the spacer may have a trapezoidal shape in cross-section, where the length of either side is greater than the height. Alternatively or additionally, step-like profiles may be used, e.g. in combination with a trapezoidal shape. Hourglass cross-sectional shapes may be employed as well, thereby leveraging the concave sides to define a creepage distance higher than the clearance. The spacer may also have a double pyramid shape in cross-section. Other examples may include donut shaped spacers, among others described herein.

As described above, the spacer 120 is made of an electrically-insulating material. According to one example, the spacer 120 may include a layer of a thermally-insulating material, such as e.g. mica, thereby combining electrical insulation with thermal insulation and at the same time increasing creepage. This is described in more detail with respect to FIGS. 8A and 8B. It's also possible to use a combination of two or more materials, fixed together, aimed to pursue previous targets of insulation and creepage.

The IEC standards may also include various clearances through the air. For example, certain impulse voltages rated up to 300V is 250V and the maximum working voltage is 250V define a minimum clearance through air of 1.5 mm. Supplementary insulation shall be not less than 1.5 mm. Reinforced insulation shall be not less than 3.0 mm. Function insulation shall be not less than 1.5 mm.

Further to these requirements, supplementary insulation and reinforced insulation may have adequate thicknesses, or sufficient number of layers to withstand the electrical stresses that can be expected during the use of the appliance. The thickness of the insulation shall be at least 1 mm for supplementary insulation. In this example, glass-ceramic is 4 mm thick and therefore compliant. The thickness shall be at least 2 mm for reinforced insulation. In this example, glass-ceramic is not considered.

Referring specifically to FIG. 6 illustrates a side view of a cooking system 100. In this example, the spacer 120 is arranged between the coil 106 and the surface 104. A clearance distance D1 is defined between the coils 106 and the surface 104 and may define the area of basic insulation. In one example, the clearance distance D₁ may be 4.0 mm.

The spacer 120 may form a shape that allows for a creepage 136 on all sides of the spacer 120. The example shown in FIG. 5 illustrates a symmetrical spacer 120, but such symmetry is not necessary.

Instead, the example in FIG. 6 illustrates an asymmetrical shape. On a first side 140 the spacer 120 may form a first step 142. On a second side 144 the spacer 120 may form a second step 146. While this example is illustrated to show the difference between how creepage distance is determined based on the height of a step-like notch, the spacer 120 may nonetheless take on many shapes and forms.

Similar to the example shown in FIG. 5, the first face 132 may have a shorter length than the second face 134. Each of the first step 142 and the second step 146 are defined at the first face 132 such that a creepage is created at each face of the spacer 120. Additional creepage 136 may be created on a back side or front side, or the creepage may form a helical slope around the circumference of the spacer 120 as well. In the example shown, the larger first step 142 creates a first creepage distance D₁ of approximately 4 mm. The second step 146, in this example, may form a distance of less than 0.5 mm (one third of minimum clearance) from the surface 104. In this example, where the step is less than this threshold, the creepage distance is measured across the groove, as illustrated by the second creepage distance D₂ in FIG. 6.

Regardless of the shape of the creepage distance defined by shape variations created by steps, slopes, etc., the creepage distance shall be greater than the clearance distance by a distance threshold. Such threshold may be minimal or may be substantial enough to produce higher electric properties for the spacer. In one example, the threshold may be 0.1 mm. Thus, the creepage distance>clearance distance+threshold distance.

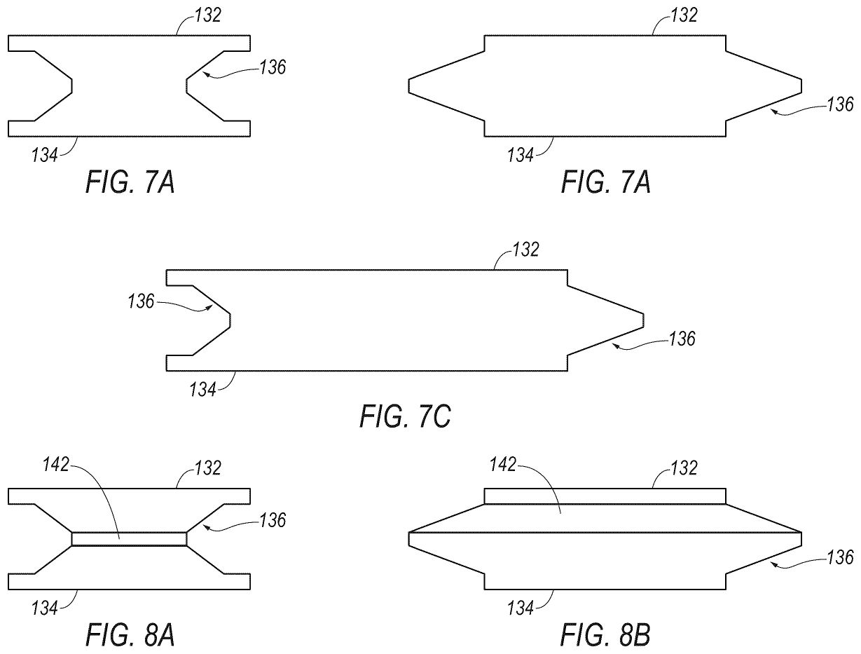

FIGS. 7A-C illustrates cross-sectional views of example spacer profiles. For example, FIG. 7A illustrates an hour-glass or concave-like cross-section. In this example, the creepage created by the shape variation at each side is symmetrical. The creepage distance is therefore greater than the clearance distance.

FIG. 7B illustrates a convex-like cross-section, or a bell-curved shape. Again, this example illustrates a symmetrical profile. FIG. 7C illustrates a spacer having an asymmetrical profile or cross-section with a convex creepage on one side and a concave creepage on the opposite side.

FIG. 8A illustrates a cross-sectional view of an example spacer profile including a second material 142 arranged within the spacer 120. The second material may be a thermal insulating material such as mica, and may be added to increase the insulating properties of the spacer 120 while still simplifying the number of parts required for the assembly 100. In this example, the additional material is arranged in the center of the spacer.

FIG. 8B illustrates a cross-sectional view of another example spacer profile including the second material 142. In this example, the second material 142 is arranged or formed as an upper portion of the spacer 120. Other examples and implementation of the second material being formed within or as part of the spacer 120 may be contemplated.

Thus, the above disclosure allows for a single spacer to be used in a coil design to be compliant with the IEC 60335 standard without using a second material or an additional insulation system in order to increase the creepage distance. As a direct result, this saves in coil part costs and manufacturing steps, as well as improves the thermal behavior of the cooktop where heat flux is not blocked by a top mica.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An inductive cooking appliance designed for half-bridge, full-bridge and quasi-resonant inverters, the inductive cooking appliance comprising:
a cooking coil for the inductive cooking appliance;
a cooktop configured to receive a cooking item, wherein the cooking coil and the cooktop are mutually spaced so as to define a clearance distance; and
a spacer arranged between the cooktop and the cooking coil, the spacer having a first face abutting the cooktop and a second face abutting the coil, wherein a length of either lateral side of the spacer creates a creepage distance between the first face and the second face in the cross-section that is greater than the clearance distance between the cooking coil and the cooktop.

2. The appliance of claim 1, wherein the spacer has a trapezoidal shape in cross-section.

3. The appliance of claim 1, wherein the spacer has a double pyramid shape in cross-section.

4. The appliance of claim 1, wherein the spacer has a concave hour-glass like cross-section.

5. The appliance of claim 1, wherein the spacer has a convex bell-shaped cross-section.

6. The appliance of claim 1, wherein the spacer is made of an electrically-insulating material.

7. The appliance of claim 1, wherein the spacer includes at least one layer of a thermally-insulating material.

8. The appliance of claim 1, wherein the creepage distance is greater than the clearance distance by a threshold distance.

9. The appliance of claim 6, wherein the threshold distance is at least 0.1 mm.

10. An inductive cooking appliance designed for half-bridge, full-bridge and quasi-resonant inverters, the inductive cooking appliance comprising:
a cooking coil for the inductive cooking appliance;
a cooktop configured to receive a cooking item; and
a spacer arranged between the cooktop and the cooking coil, the spacer having a first face and a second face arranged between the coil and the cooktop, wherein between the two face there is a shape variation that creates a creepage distance between the first and second face that is greater than a clearance distance between the cooking coil and the cooktop.

11. The appliance of claim 10, further comprising at least one additional insulating layer arranged between the cooktop and the coil.

12. The appliance of claim 11, wherein the additional insulating layer is arranged between the spacer and the cooktop.

13. The appliance of claim 11, wherein the additional insulating layer is arranged between the spacer and the coil.

14. The appliance of claim 11, further comprising more than one spacer arranged between the cooktop and an additional insulating layer/s.

15. The appliance of claim 10, wherein the spacer includes a second material, the second material being thermal and/or electrical insulating.

16. The appliance of claim 10, wherein the spacer forms a trapezoidal, hour-glass or bell shape in cross section.

17. The appliance of claim 10, wherein the creepage is at least one corner notch at the first surface forming a step-like cross section.

18. A spacer for an inductive cooking appliance, comprising:
a first face and a second face opposite the first face,
the first face having a first length,
the second face having a second length, wherein between the two faces there is a shape variation that increases the creepage between the first and second side.

19. The spacer of claim 16, wherein creepage distance is greater than 0.18 mm.

20. The appliance of claim 16, wherein the creepage distance is greater than the clearance distance by a threshold distance.
